(19) United States
(12) Patent Application Publication
(10) Pub. No.: US 2025/0193235 A1
(43) Pub. Date: Jun. 12, 2025

(54) DIAGNOSIS APPARATUS, LINE EXCHANGER, DIAGNOSTIC METHOD, AND PROGRAM

(71) Applicant: NEC Platforms, Ltd., Kawasaki-shi (JP)

(72) Inventor: Hiroyo YAMAMOTO, Kanagawa (JP)

(73) Assignee: NEC Platforms, Ltd., Kawasaki-shi (JP)

(21) Appl. No.: 18/953,274

(22) Filed: Nov. 20, 2024

(30) Foreign Application Priority Data
Dec. 12, 2023 (JP) 2023-209225

(51) Int. Cl. H04L 9/40

(52) U.S. Cl. CPC H04L 63/1466

(57) ABSTRACT

A diagnosis apparatus or the like including a configuration information acquisition part that acquires configuration information that is configuration content of a target device; a diagnostic rule holding part that holds a diagnostic rule for diagnosing the configuration information; a diagnosis part that diagnoses the target device on a basis of the diagnostic rule; and a diagnostic result notification part that notifies a diagnosis result, wherein the diagnostic rule holding part holds the diagnostic rule that diagnoses whether or not the configuration information is a secure configuration from a security perspective is provided.

### FIELD

### Cross Reference to Related Applications

This application is based upon and claims the benefit of the priority of Japanese patent application No. 2023-209225, filed on Dec. 12, 2023, the disclosure of which is incorporated herein in its entirety by reference thereto.

The present disclosure provides a diagnosis apparatus, a line exchanger, a diagnostic method, and a program that can prevent damage by simply and quickly taking measures against unauthorized utilization and unauthorized access to an apparatus or the like from the outside.

### BACKGROUND

Unauthorized utilization and unauthorized access to a line exchanger on a communication network from an external party is increasing. Vendors or the like provide users with a recommendation configuration to prevent such attacks. At a time when building a new system, it is common to configure it according to this recommendation configuration. However, due to non-application thereof to existing systems, oversight of risks, etc., damage has occurred even after the release of the recommendation configuration information.

Patent Literature (PTL) 1 discloses following invention. In the invention, it is configured that an IP (Internet Protocol) phone terminal adapter automatically acquire a number unique to its own device and distinctive from a home optical device, which is an upper device of the IP phone terminal adapter, during authentication, and uses the number acquired automatically as a password for an IP telephone. Therefore, compared to a conventional configuration in which an end user sets a password for the IP telephone in the IP phone terminal adapter, this invention prevents the password from being stolen. As a result, spoofing by the end user can be suppressed in an IP telephony connection over FTTH (Fiber To The Home). In addition, because a password for the IP telephone of any user is tied to an optical device on a line of that user (communication path), it is possible to implement a mechanism that can only be used on the line of that user.
[PTL 1] Japanese Unexamined Patent Application Publication No. 2005-341374 A

### SUMMARY

The disclosure of PTL 1 is incorporated herein by reference thereto. The following analysis is given by the present inventor.

As described above, the invention disclosed in PTL 1 can prevent unauthorized utilization by spoofing and unauthorized utilization by an authentication method. Although applying a recommendation configuration to an exchanger can be expected to have a considerable effect, the recommendation configuration is, however, often not applied at an appropriate timing to exchangers already in operation, and this is an issue for the present disclosure.

From a viewpoint of the present disclosure, it is an object to provide a diagnosis apparatus, a line exchanger, a diagnostic method, and a program that can prevent damage by simply and quickly taking measures against unauthorized utilization and unauthorized access to an apparatus or the like from the outside.

According to a first aspect of the present disclosure, there is provided a diagnosis apparatus, including:
a configuration information acquisition part that acquires configuration information that is configuration content of a target device;
a diagnostic rule holding part that holds a diagnostic rule for diagnosing the configuration information;
a diagnosis part that diagnoses the target device on a basis of the diagnostic rule; and
a diagnostic result notification part that notifies a diagnosis result, wherein
the diagnostic rule holding part holds the diagnostic rule that diagnoses whether or not the configuration information is a secure configuration from a security perspective.

According to a second aspect of the present disclosure, there is provided a line exchanger including the diagnosis apparatus according to the first aspect.

According to a third aspect of the present disclosure, there is provided a diagnostic method that causes a computer to execute following diagnostic method, the diagnostic method comprising:
acquiring configuration information that is configuration content of a target device;
acquiring a diagnostic rule for diagnosing the configuration information, the diagnostic rule diagnosing whether or not the configuration information is a secure configuration from a security perspective;
diagnosing the target device on a basis of the diagnostic rule; and
notifying a diagnosis result.

According to a fourth aspect of the present disclosure, there is provided a program a causing computer to execute;
a process for acquiring configuration information that is configuration content of a target device;
a process for acquiring a diagnostic rule for diagnosing the configuration information, the diagnostic rule diagnosing whether or not the configuration information is a secure configuration from a security perspective;
a process for diagnosing the target device on a basis of the diagnostic rule; and
a process for notifying a diagnosis result.

The program can be recorded in a computer-readable storage medium. The storage medium may be a non-transitory storage medium such as a semiconductor memory, a hard disk, a magnetic recording medium, or an optical recording medium. In the present disclosure, the program can be embodied as a computer program product.

According to each aspect of the present disclosure, it is possible to provide a diagnosis apparatus, a line exchanger, a diagnostic method, and a program that can prevent damage by simply and quickly taking measures against unauthorized utilization and unauthorized access to an apparatus or the like from outside.

### BRIEF DESCRIPTION OF DRAWINGS

FIG. 1 is a block diagram illustrating an example of a configuration of a diagnosis apparatus according to the present disclosure.

FIG. 2 is a diagram illustrating an example of an overview of an emergency communication process in a diagnosis apparatus according to the present disclosure.

FIG. 3 is a block diagram illustrating an example of a configuration of a diagnosis apparatus according to the present disclosure.

FIG. 4 is a diagram schematically illustrating the diagnostic rule used by a diagnosis apparatus according to the present disclosure.

FIG. 5 is a flowchart illustrating an example of an operation of the diagnosis apparatus according to the present disclosure.

FIG. 6 is a block diagram illustrating an example of a hardware configuration of the diagnosis apparatus according to the present disclosure.

FIG. 7 is a block diagram illustrating an example of a configuration of the diagnosis apparatus according to the present disclosure.

FIG. 8 is an image diagram illustrating an example of a part of a recommendation configuration database of the diagnosis apparatus according to the present disclosure.

FIG. 9 is a diagram illustrating a diagnostic processing of a determination part illustrated in FIG. 7 according to the present disclosure.

FIG. 10 is a sequence diagram illustrating an example of an operation of an example embodiment according to the present disclosure.

FIG. 11 is a sequence diagram illustrating an example of an operation of an example embodiment according to the present disclosure.

FIG. 12 is a sequence diagram illustrating an example of an operation of an example embodiment according to the present disclosure.

### EXAMPLE EMBODIMENTS

First, an overview of an example embodiment will be described. Note that reference signs in the drawings provided in the overview are for the sake of convenience for each element as an n example to promote better understanding, and description of the overview is not to impose any limitations. In the present disclosure, the drawings may relate to or more example one embodiment(s).

### [Configuration]

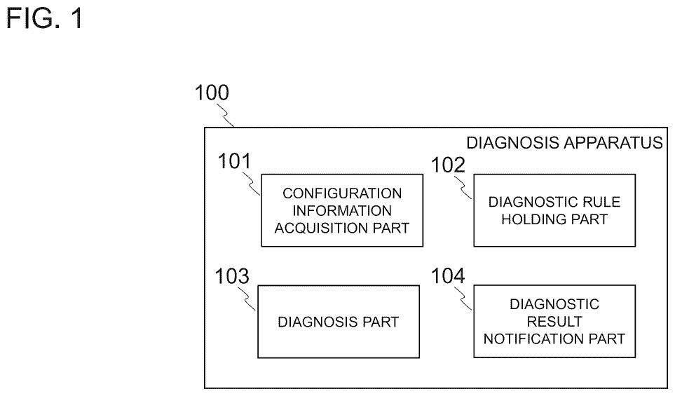

FIG. 1 illustrates a block diagram of an example of a configuration of a diagnosis apparatus 100 of the present disclosure. The diagnosis apparatus 100 of the present disclosure is provided with a configuration information acquisition part 101, a diagnostic rule holding part 102, a diagnosis part 103, and a diagnostic result notification part 104.

The configuration information acquisition part 101 acquires configuration information, which is configuration content of a target device. The diagnostic rule holding part 102 holds a diagnostic rule for diagnosing the configuration information. The diagnosis part 103 diagnoses the target device on a basis of the diagnostic rule. The diagnostic result notification part 104 notifies a result of a diagnosis. The diagnostic rule holding part 102 holds the diagnostic rule that diagnoses whether or not the configuration information is a secure configuration from a security perspective.

In this way, the diagnosis apparatus 100 of the present disclosure can obtain a diagnostic result by diagnosing the configuration information of the target device with the holding diagnostic rules. The holding diagnostic rule is a rule to diagnose whether or not a configuration is secure from a security perspective. This allows a user to know whether the configuration information is secure for unauthorized access and unauthorized utilization.

### First Example Embodiment

### [Process Overview]

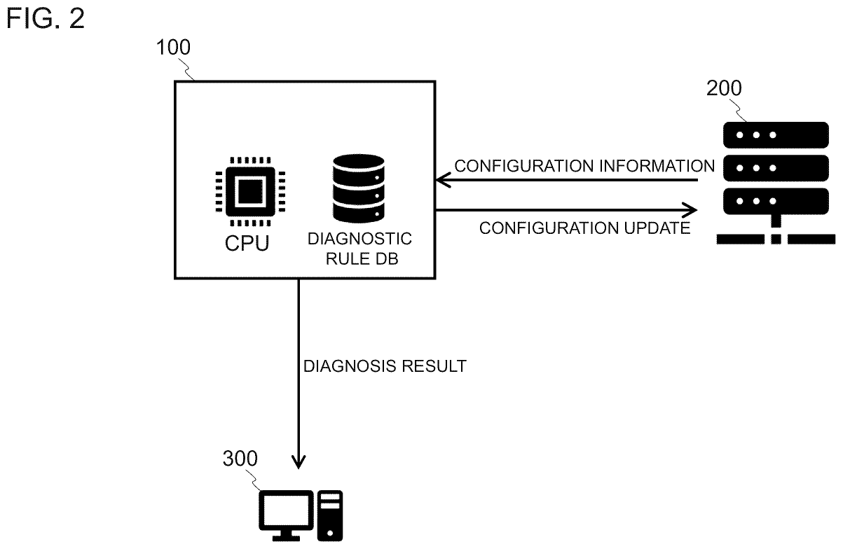

FIG. 2 is a diagram illustrating an example of an overview of a process performed by a diagnosis apparatus of the present disclosure. As illustrated in this diagram, there is a diagnosis apparatus 100, a target device 200, and a terminal apparatus 300. These are connected via a network. The diagnosis apparatus 100 is provided with a CPU (Central Processing Unit) and a memory area. The memory area may hold a diagnostic rule DB (database) in which a diagnostic rule is stored. This diagnostic rule DB may be built in the diagnosis apparatus 100 as illustrated in FIG. 2, or it may be held on a separate server connected to the network.

The diagnosis apparatus 100 acquires configuration information from the target device 200. The diagnosis apparatus 100 performs diagnosis of the acquired configuration information using the diagnostic rule held in the diagnostic rule DB. The configuration information set in the target device 200 may be a recommendation configuration to be generally secure from a security perspective in the target device. The diagnosis apparatus 100 transmits a diagnosis result to the terminal apparatus 300 as a notification.

The diagnosis apparatus 100 may perform a process for updating a configuration for the target device 200 on a basis of the diagnosis result and the diagnostic rule.

### [Configuration]

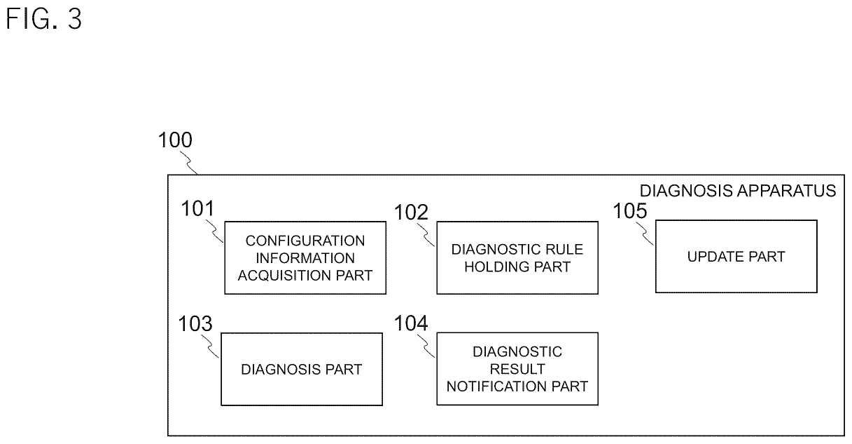

FIG. 3 is a diagram illustrating an example of a configuration of the diagnosis apparatus 100 according to the first example embodiment. The diagnosis apparatus 100 according to the first example embodiment is provided with a configuration information acquisition part 101, a diagnostic rule holding part 102, a diagnosis part 103, a diagnostic result notification part 104, and an update part 105.

The configuration information acquisition part 101 acquires configuration information, which is configuration content of a target device. The “target device” is a device to be diagnosed, such s a communication server apparatus including a Web server. The “configuration information, which is configuration content” is information that includes configurations mainly related to communication network among configurations of the target device 200. This configuration information may be, for example, a configuration for port for providing service or for Domain Name System (DNS), or a recommendation configuration, recommended from a security perspective, as configuration content for the target device. This recommendation configuration is a general configuration for connecting to the communication network and does not have to be set after adjustments are made to suit the usage conditions.

The diagnostic rule holding part 102 holds the diagnostic rule for diagnosing the configuration information. Unlike the recommendation configuration, the “diagnostic rule” is a rule to derive an individual and concrete configuration according to network environment in which the target device 200 is disposed.

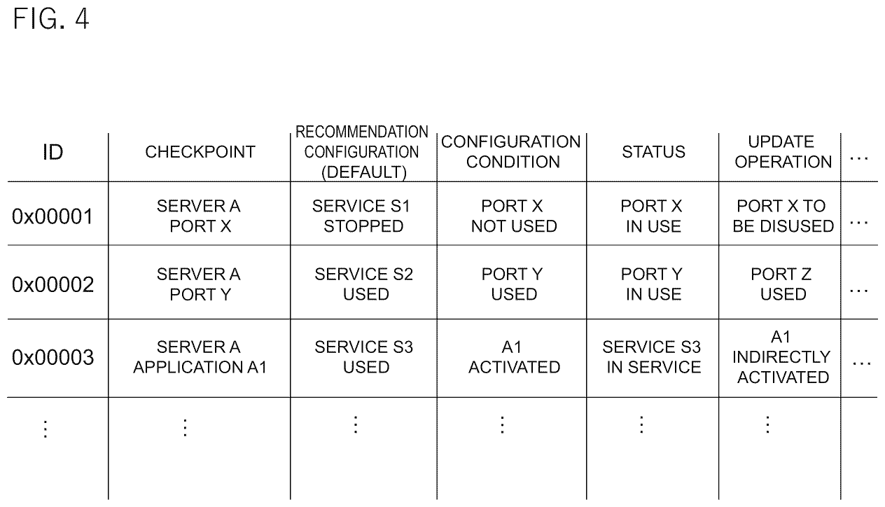

FIG. 4 is a diagram schematically illustrating the diagnostic rule used by the diagnosis apparatus 100 according to the present disclosure. As illustrated in this diagram, this rule may be, for example, a checkpoint system. The checkpoint system refers to a system in which some or all of a list of checkpoints are diagnosed in sequence. In the diagnosis, a diagnostic result of a system operation is obtained under the configuration condition, which is a current configuration after receiving the recommendation configuration, and a necessary update operation is derived from a security perspective. For example, if the checkpoint (rule ID: 0x00001) is a configuration for a port X of a server A, in the recommendation configuration, a service S1 is recommended to be stopped for a security reason (recommendation configuration) a t the port X (checkpoint), and the port X is set not to be used by the target device 200 (configuration condition). Nevertheless, the diagnostic result shows that the port X is in use (status). In such a case, the port X is set to be disused (update operation). In this way, the rule is used to perform a series of diagnostics and updates. At least a series of these checkpoint, recommendation configuration, configuration condition, status, and update operation may be a rule element, and the set thereof may be referred to as a “diagnostic rule.

For example, if the checkpoint is an application A1 (rule ID: 0x00003) for server A, the recommendation configuration is to provide a service S3. Therefore, the server is in a situation that directly activates the application A1, and in the diagnostic result, the service S3 is in service. In an example illustrated in FIG. 4, an operation to update an application startup mode so that the A1 is not started directly, but indirectly from wrapper software, etc., for security reasons, is derived

The diagnosis part 103 diagnoses the target device on a basis of the diagnostic rule. The diagnosis part 103 diagnoses the target device at each check point using the diagnostic rule described above and outputs the diagnosis results.

The diagnostic result notification part 104 notifies the diagnosis results. Specifically, it refers to notifying the diagnosis results output by the diagnosis apparatus 100 to the terminal apparatus 300, etc., via a network. The notified diagnostic results are output via a display device or the like included in an input/output interface of the terminal apparatus 300.

The update part 105 updates a configuration of the target device 200 on a basis of the diagnosis results and the diagnostic rule held in the diagnostic rule holding part 102. Specifically, the update part 150 performs the update operation derived from the diagnostic rule as described above to update the configuration of the target device 200.

The update part 105 may update the configuration of the target device in response to updates of the diagnostic rule held in the diagnostic rule holding part 102. For example, in FIG. 4, if the “recommendation configuration” in the diagnostic rule is changed according to the situation, the update part 105 may change the “update operation” accordingly and update the “configuration information”

The diagnosis apparatus 100 may be further provided with a diagnostic rule editing reception part (not shown) for editing the diagnostic rules in the diagnostic rule holding part. In a case where the diagnostic rule is changed by editing, the diagnosis apparatus 100 may immediately perform a process of updating the configuration information as described in the update part 105 above.

### [Description of Operation]

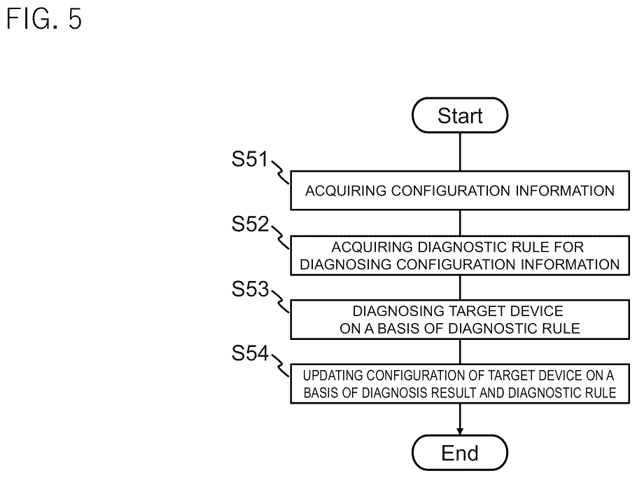

FIG. 5 is a flowchart illustrating an example of an operation of the diagnosis apparatus 100 according to the present disclosure. As illustrated in this diagram, upon starting the operation, the diagnosis apparatus 100 first acquires the configuration information (step S51). Then, the diagnosis apparatus 100 acquires the diagnostic rule for diagnosing the configuration information (step S52). The diagnosis apparatus 100 then diagnoses the target device on a basis of the diagnostic rule (step S53). After diagnosis, the diagnosis apparatus 100 updates the configuration of the target device on a basis of the diagnosis results and the diagnostic rule (step S54), and completes the series of processes.

### [Hardware Configuration]

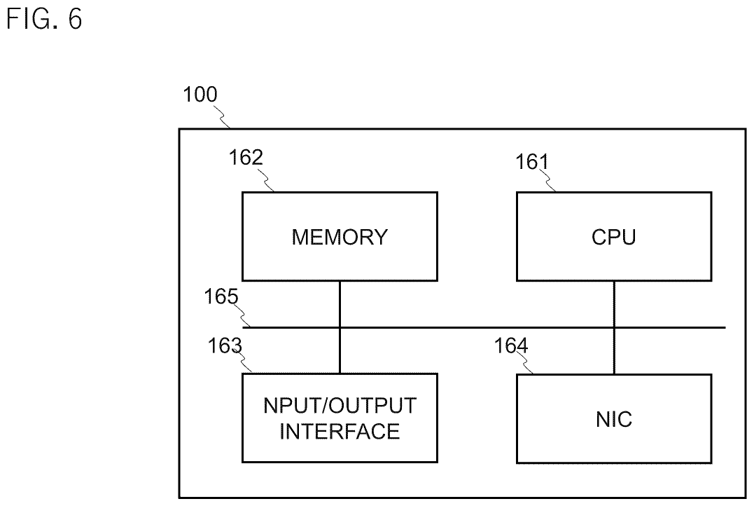

FIG. 6 is a block diagram illustrating an example of a hardware configuration of the diagnosis apparatus 100 according to the present disclosure. The diagnosis apparatus 100 can be configured by an information processing apparatus (computer) and is provided with the configuration illustrated in FIG. 6. For example, the diagnosis apparatus 100 is provided with a CPU (Central Processing Unit) 161, a memory 162, an input/output interface 163, a communication means NIC (Network Interface Card) 164, etc., which are communication means, and the like, each of which is connected to each other by an internal bus 165.

However, the configuration illustrated in FIG. 6 is not intended to limit the hardware configuration of the devices that configure the diagnosis apparatus 100. The diagnosis apparatus 100 may include hardware(s) not shown, respectively, or may not be provided with an input/output interface 163, if not needed. The number of CPU(s) etc. included in the diagnosis apparatus 100 is not intended to be limited to the example illustrated in FIG. 6. For example, a plurality of CPUs may be included in each apparatus.

The memory 162 is a RAM (Random Access Memory), a ROM (Read-Only Memory), or an auxiliary storage device (such as a hard disk).

The input/output interface 163 is means that serves as an interface to a display device or an input device not shown in the drawing. For example, the display device is a liquid crystal display. The input device is, for example, a device that accepts user operations, such as a keyboard or a mouse.

The functions of the diagnosis apparatus 100 are realized by the processing modules, such as, a configuration information acquisition program, a diagnostic rule acquisition program, a diagnostic program, a diagnostic result notification program, and a n update program, diagnostic result notification program, and update program. The data used by the above modules include diagnostic rule data, etc.

The processing modules above are realized, for example, by the CPU 161 executing each program stored in the memory 162. The program can be updated by downloading via the network or using a storage medium storing the program. The processing modules may be realized by a semiconductor chip. In other words, there may be means that executes the functions performed by the processing modules, using some kind of hardware and/or software.

### [Hardware Operation]

After the diagnosis apparatus 100 starts an operation, the configuration information acquisition program is first called from the memory 162 by the CPU 161 and is to be in execution state. The program connects the diagnosis apparatus 100 to the target device 200 via NIC 164 and acquires the configuration information. For example, a configuration file can be acquired by downloading directly, or by being written up from a configuration status of the apparatus. The configuration status is obtained by scanning ports etc. The configuration information is temporarily stored in memory 162.

The diagnostic rule acquisition program is, next, called from the memory 162 by the CPU 161 and is to be in execution state. The program accesses the diagnostic rule DB held in the memory 162 and reads out the diagnostic rule to another area on the memory 162.

The diagnostic program is, next, called from the memory 162 by the CPU 161 and is to be in execution state. The program reads the configuration information which is acquired and is temporarily stored in the memory 162 and the diagnostic rule which is also stored in the memory 162. The program collates the written configuration information with the “condition” part of the diagnostic rule (“check point”, “configuration condition”, and “status” in FIG. 4) and determines whether or not it matches. If it matches, the program reads out the “update operation” of the matching rule and stores it in a separate area of the memory 162.

The update program is, next, called from the memory 162 by the CPU 161 and is to be in execution state. The program reads the “update operation” stored in the separate area of the memory 162, accesses the target device 200 via the NIC 164, etc., and executes an update process.

### [Explanation of Effect]

As described above, the diagnosis apparatus 100 of the present disclosure uses diagnostic rules to diagnose the configuration information of the target device to determine whether it is secure from a security perspective. This makes it possible to provide a diagnosis apparatus, a line exchanger, a diagnostic method, and a program which can prevent damage by simply and quickly taking measures against unauthorized utilization and unauthorized access to an apparatus or the like from the outside.

### Example Embodiment

[Process overview]
In the example embodiment, an example in which a diagnosis apparatus 100 of the present disclosure is mounted on a line exchanger on a telephone line or the like is described.

### [Apparatus Configuration]

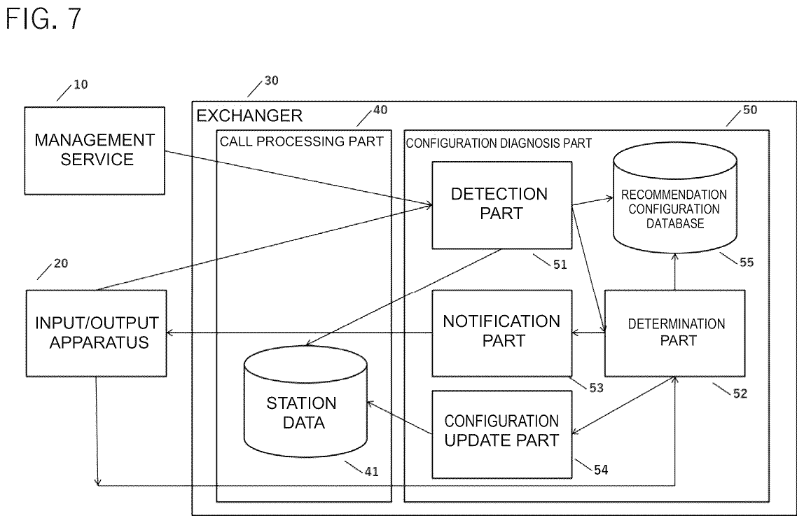

FIG. 7 is a block diagram illustrating an example of a configuration of a line exchanger of the example embodiment according to the present disclosure. As illustrated in this diagram, the present example embodiment is configured with an exchanger 30, an input/output apparatus 20, and a management service 10. The exchanger 30 is provided with a call processing part and a configuration diagnosis part 50. The configuration diagnosis part 50 is a new part to be added in the present example embodiment. The call processing part 40 is a part that operates various services of a telephone set and is provided with station data 41 that is configuration data for it.

The configuration diagnosis part 50 is provided with a detection part 51, a determination part 52, a notification part 53, a configuration update part 54, and a recommendation configuration database 55. The detection part 51 reads out the station data 41 and the recommendation configuration database 55. The determination part 52 compares the station data 41 and the recommendation configuration database 55 to perform risk diagnosis. The notification part 53 notifies a diagnosis result to the input/output apparatus 20. The configuration update part 54 can also update the station data 41 to the recommendation configuration after diagnosis.

Since a recommendation configuration differs depending on a system configuration and a service used, the recommendation configuration database 55 has information on the recommendation configuration adapted to each condition. In addition, not only the station data 41 but also settings of accommodation devices of the exchanger, such as a telephone set, a telephone line, or the like, as well as external devices, such as a router, or the like, are also necessary data for fraud prevention. Therefore, the recommendation configuration database 55 has their recommendation configuration information. In addition, the recommendation configuration database 55 has information that serves as a criterion for judgment, such as a meaning of setting value of each data and a reason for setting it to that value, so that the user can determine whether or not it is safe to change to the recommendation configuration.

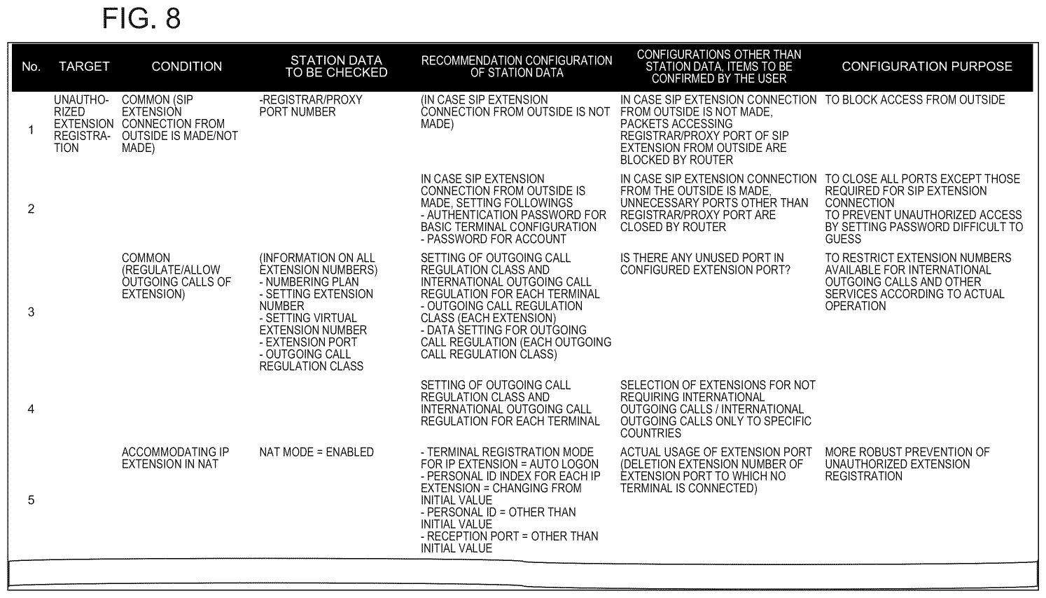

FIG. 8 is an image diagram illustrating an example of a part of the recommendation configuration database 55. No. 1 to No. 4 in FIG. 8, where each condition is “common,” are data which are to be checked in all systems. For example, recommendation configurations for conditions of No. 1 and No. 2 are different depending on whether or not SIP (Session Initiation protocol) extension connection from outside is made. Therefore, these conditions are not set by the station data configuration, but need to be selected by the user. In addition, since a configuration for the router, which is an external device, is also necessary, its recommendation configuration is described in a “configurations other than station data, items to be confirmed by the user”

### FIELD

No. 5 in FIG. 8 has a condition that “IP extension is accommodated by NAT (Network Address Translation)”. Therefore, if NAT mode is enabled in the station data, it is necessary to compare the station data with the recommendation configuration. It is also necessary to check whether or not the extension is actually connected. For this reason, this is described in the “configurations other than station data, items to be confirmed by the user”

### FIELD

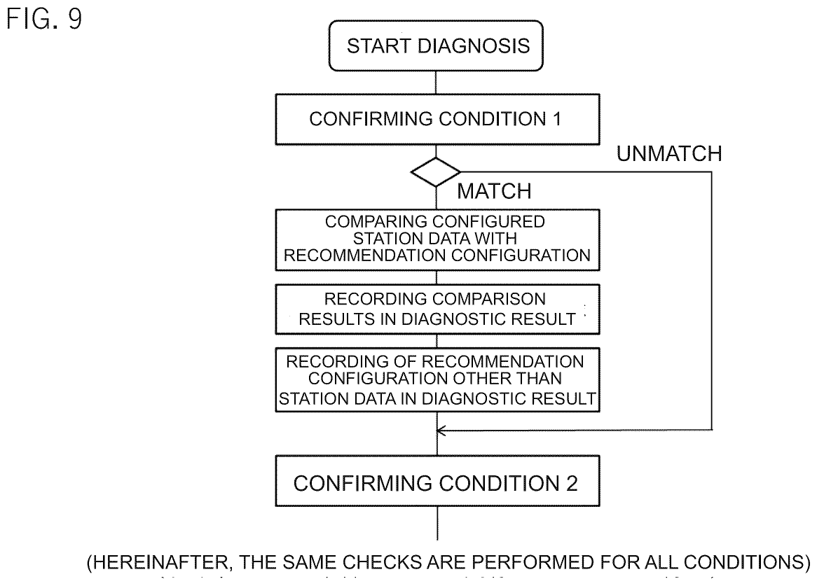

FIG. 9 is a diagram illustrating a diagnostic processing of the determination part 52 illustrated in FIG. 7. In a “confirmation of condition 1” process in FIG. 9, the determination part 52 checks the “condition” and the “station data to be checked” of “No. 1” in FIG. 8. If conditions match, it performs a “comparing the set station data with the recommendation configuration” process and subsequent processes to record a diagnosis result for condition 1. The determination part 52 performs diagnosis for each condition in this manner and the notification part 53 notifies diagnosis results for all conditions.

### [Description of Operation of the Example Embodiment]

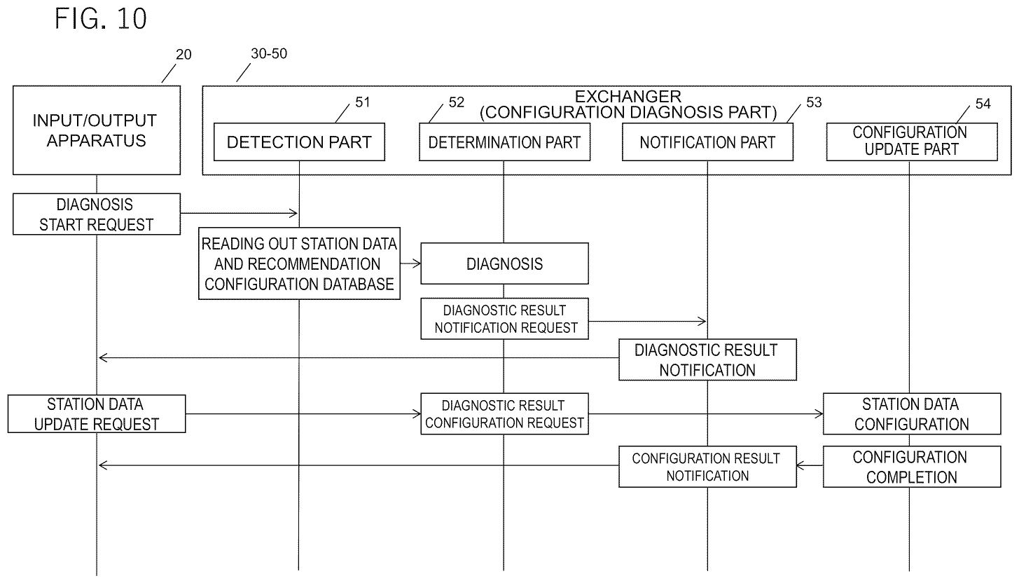

The operation of one example embodiment of the present disclosure is described using FIG. 10. Upon receiving a request from a user to start diagnosis the input/output to exchanger 30, the apparatus 20 configuration diagnosis part 50 of the exchanger 30 causes the detection part 51 to read out station data 41 and the recommendation configuration database 55, causes the determination part 52 to compare and diagnose them, and returns a diagnosis result to the input/output apparatus 20 from the notification part 53. The user checks the diagnostic results through the input/output apparatus 20, and if there are no problems in changing the station data 41 according to the recommendation configuration, the user submits a station data update request. Upon receiving the station data update request, the determination part 52 requests the configuration update part 54 to set the recommendation data. After the configuration update is complete, the configuration diagnosis part 50 notifies the input/output apparatus 20 of the results from the notification part 53. The “diagnosis” performed by the determination part 52 corresponds to the diagnostic process in FIG. 9.

### [Explanation of Another Example Embodiment]

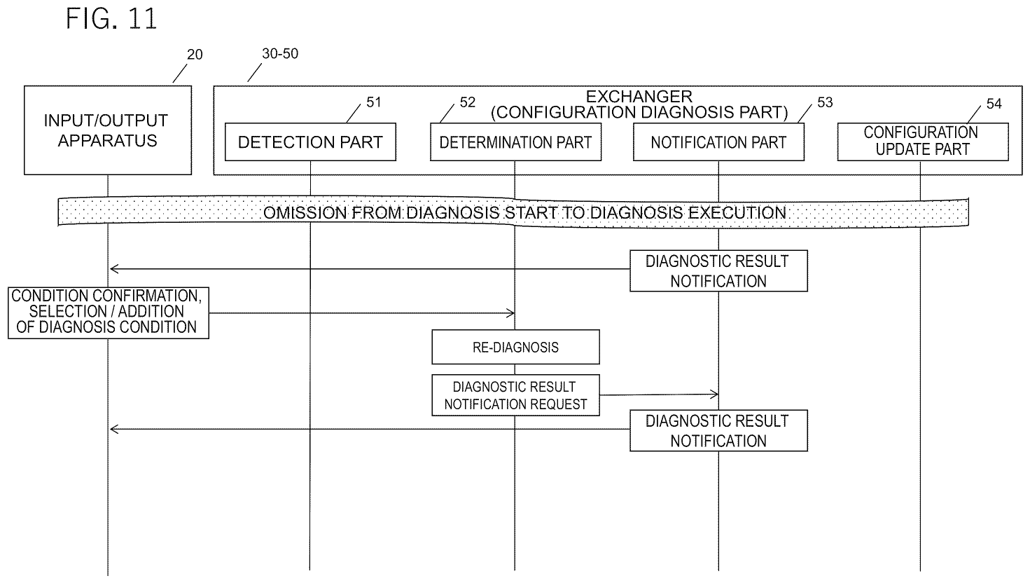

In a case where the diagnosis result notification is received in the above example embodiment, if more detailed condition is needed to add, the user can select/add a diagnosis condition(s) after checking the diagnosis result notification, as described in FIG. 11, and the configuration diagnosis part 50 of the exchanger can cause the determination part 52 to perform re-diagnosis. This re-diagnosis process may be performed multiple times if necessary. For example, if the “SIP extension connection from outside is made” matches an operation condition of the user in No. 1 and No. 2 of FIG. 8, the user adds that condition and requests a re-diagnosis, then No. 2 is selected as the recommender data.

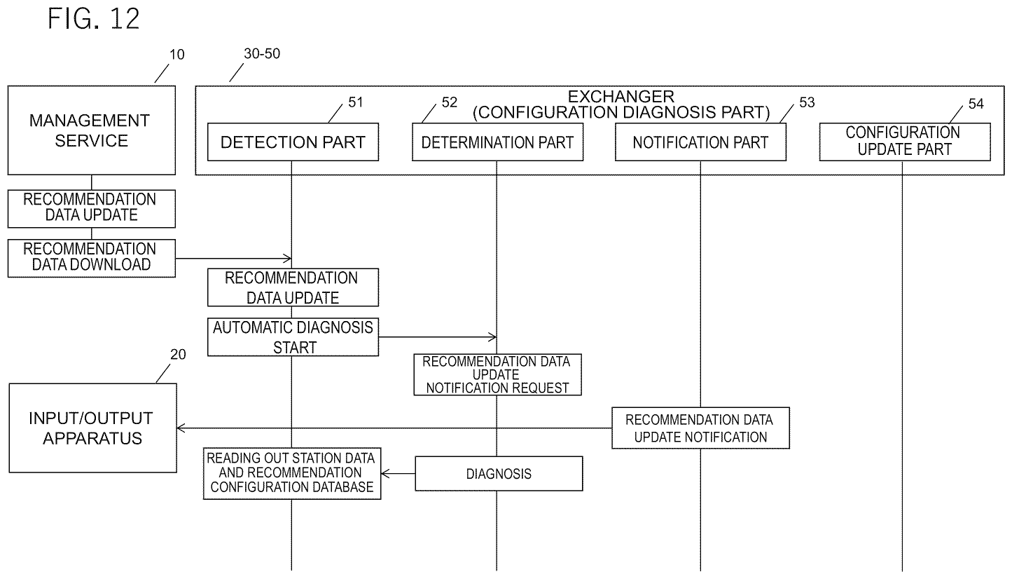

It is also possible to automatically update and diagnose the recommendation configuration database in the exchanger to diagnose in a case where the recommendation configuration information is updated. This is explained using FIG. 12. To manage one or more exchangers 30, the management service 10, which is connected via the Internet, manages recommendation configuration information. In a case where a new risk is found, the recommendation configuration information held by the management service 10 is updated. At this time, the management service 10 downloads the recommendation configuration information to a 11 connected exchangers 30 to update the recommendation configuration database 55.

After the recommendation configuration database 55 is updated, the exchangers 30 automatically use the updated recommendation configuration database 55 to perform diagnostics. It also notifies the input/output apparatus 20 that the recommendation configuration database 55 has been updated. The process(es) after diagnosis is the same as in a case of manual diagnosis illustrated in FIG. 9. In this case, it is also possible to centrally manage the notifications by setting a notification destination to the management service 10 instead of the input/output apparatus 20. Even without a diagnosis start request from the input/output apparatus 20, it is also possible to start diagnosis automatically at a time when a system version is upgraded, or a setting of the station data is changed.

A part or a whole of the above-mentioned modes may be described as, but not limited to, the following supplementary notes (Notes).

### [Note 1]

Refer to the diagnosis apparatus according to the first aspect described above.

### [Note 2]

In the diagnosis apparatus described in Note 1, it is preferable that the configuration information acquisition part acquires a recommendation configuration that is recommended from a security perspective, as default configuration content for a target device.

### [Note 3]

The diagnosis apparatus described in Note 1 or 2, preferably further includes an update part that updates a configuration of a target device on a basis of the diagnosis result and the diagnostic rule held in the diagnostic rule holding part.

### [Note 4]

In the diagnosis apparatus described any one of Notes 1 to 3, it is preferable that the diagnostic rule holding part holds a diagnostic rule including a list of checkpoints.

### [Note 5]

In the diagnosis apparatus described any one of Notes 1 to 4, it is preferable that the update part updates the configuration of the target device in response to an update of the diagnostic rule held in the diagnostic rule holding part.

### [Note 6]

The diagnosis apparatus described in any one of Notes 1 to 5, preferably further includes a diagnostic rule editing reception part for editing the diagnostic rule in the diagnostic rule holding part.

### [Note 7]

Refer to the line exchanger according to the second aspect described above.

### [Note 8]

In the line exchanger described in Note 7, it is preferable that the diagnostic rule holding part comprised in the diagnosis apparatus holds a diagnostic rule regarding unauthorized extension registration.

### [Note 9]

Refer to the diagnosis method according to the third aspect described above.

### [Note 10]

Refer to the program according to the fourth aspect described above.
The Notes 9 and 10 can be expanded in the same manner as Note 1 is expanded to Notes 2 to 6.

Each disclosure of above cited PTL, etc., is incorporated herein by reference thereto. Modifications and adjustments of the example embodiments or examples are possible within the scope of the overall disclosure (including the claims) of the present invention and based on the basic technical concept of the present invention. Various combinations and selections of examples and disclosed elements (including the elements in each of the claims, example embodiments, examples, drawings, etc.) are possible within the scope of the claims of the present invention. That is, the present disclosure includes various variations and modifications that could be made by those skilled in the art according to the overall disclosure including the claims and the technical concept. Particularly, any numerical ranges disclosed herein should be interpreted that any intermediate values or subranges falling within the disclosed ranges are also concretely disclosed even without specific recital thereof.

### REFERENCE SIGNS LIST

10: management service
20: input/output apparatus
30: exchanger
40: call processing part
41: station data
50: configuration diagnosis part
51: detection part
52: determination part
53: notification part
54: configuration update part
55: recommendation configuration database
100: diagnosis apparatus
101: configuration information acquisition part
102: diagnostic rule holding part
103: diagnosis part
104: diagnostic result notification part
105: update part
161: CPU
162: memory
163: input/output interface
164: NIC
165: internal bus
200: target device
300: terminal apparatus

What is claimed is:

1. A diagnosis apparatus, comprising:
at least a processor; and
a memory in circuit communication with the processor,
wherein the processor is configured to execute program instructions stored in the memory to implement:
a configuration information acquisition part that acquires configuration information that is configuration content of a target device;
a diagnostic rule holding part that holds a diagnostic rule for diagnosing the configuration information;
a diagnosis part that diagnoses the target device on a basis of the diagnostic rule; and
a diagnostic result notification part that notifies a diagnosis result, wherein
the diagnostic rule holding part holds the diagnoses whether not the diagnostic rule that configuration information is a secure configuration from a security perspective.

2. The diagnosis apparatus according to claim 1, wherein
the configuration information acquisition part acquires a recommendation configuration that is recommended from a security perspective, as default configuration content for a target device.

3. The diagnosis apparatus according to claim 1, wherein the processor is further configured to execute program instructions stored in the memory to implement:
an update part that updates a configuration of a target device on a basis of the diagnosis result and the diagnostic rule held in the diagnostic rule holding part.

4. The diagnosis apparatus according to claim 1, wherein
the diagnostic rule holding part holds the diagnostic rule including a list of checkpoints.

5. The diagnosis apparatus according to claim 3, wherein
the update part updates the configuration of the target device in response to an update of the diagnostic rule held in the diagnostic rule holding part.

6. The diagnosis apparatus according to claim 1, wherein the processor is further configured to execute program instructions stored in the memory to implement:
a diagnostic rule editing reception part that edits the diagnostic rule in the diagnostic rule holding part.

7. The diagnosis apparatus according to claim 2, wherein the processor is further configured to execute program instructions stored in the memory to implement:
an update part that updates a configuration of a target device on a basis of the diagnosis result and the diagnostic rule held in the diagnostic rule holding part.

8. The diagnosis apparatus according to claim 2, wherein
the diagnostic rule holding part holds the diagnostic rule including a list of checkpoints.

9. The diagnosis apparatus according to claim 3, wherein
the diagnostic rule holding part holds the diagnostic rule including a list of checkpoints.

10. The diagnosis apparatus according to claim 2, wherein the processor is further configured to execute program instructions stored in the memory to implement:
a diagnostic rule editing reception part that edits the diagnostic rule in the diagnostic rule holding part.

11. The diagnosis apparatus according to claim 3, wherein the processor is further configured to execute program instructions stored in the memory to implement:
a diagnostic rule editing reception part that edits the diagnostic rule in the diagnostic rule holding part.

12. The diagnosis apparatus according to claim 4, wherein the processor is further configured to execute program instructions stored in the memory to implement:
a diagnostic rule editing reception part that edits the diagnostic rule in the diagnostic rule holding part.

13. A line exchanger comprising:
the diagnosis apparatus according to claim 1.

14. The line exchanger according to claim 13, wherein
the diagnostic rule holding part comprised in the diagnosis apparatus holds a diagnostic rule regarding unauthorized extension registration.

15. A line exchanger comprising:
the diagnosis apparatus according to claim 2.

16. A line exchanger comprising:
the diagnosis apparatus according to claim 3.

17. A line exchanger comprising:
the diagnosis apparatus according to claim 4.

18. A line exchanger comprising:
the diagnosis apparatus according to claim 5.

19. A diagnostic method executed by a computer, comprising:
acquiring configuration information that is configuration content of a target device;
acquiring a diagnostic rule for diagnosing the configuration information, the diagnostic rule diagnosing whether or not the configuration information is a secure configuration from a security perspective;
diagnosing the target device on a basis of the diagnostic rule; and
notifying a diagnosis result.

20. A non-transitory computer readable medium storing a program causing a computer to execute processings comprising:
acquiring configuration information that is configuration content of a target device;
acquiring a diagnostic rule for diagnosing the configuration information, the diagnostic rule diagnosing whether or not the configuration information is a secure configuration from a security perspective;
diagnosing the target device on a basis of the diagnostic rule; and
notifying a diagnosis result.
